(19) United States
(12) Patent Application Publication
(10) Pub. No.: US 2007/0086403 A1
(43) Pub. Date: Apr. 19, 2007

(54) Transmitting and receiving system, transmitting equipment, and transmitting method

(76) Inventors: Takeshi Hatakeyama, Osaka (JP); Akifumi Nagao, Osaka (JP); Masataka Irie, Osaka (JP)

Correspondence Address: MCDERMOTT WILL & EMERY LLP, 600 13TH STREET, N.W., WASHINGTON, DC, 20005-3096, US

(21) Appl. No.: 11/541,659

(22) Filed: Oct. 3, 2006

(30) Foreign Application Priority Data
Oct. 19, 2005 (JP) 2005-304723
Aug. 10, 2006 (JP) 2006-218358

(51) Int. Cl. H04Q 7/24

(52) U.S. Cl. 370/338; 370/373

(57) ABSTRACT

In a case where it is determined that communication data indicates a first data attribute in a transmitter, that communication data is transmitted and an acknowledgement signal is requested to be sent back from a receiver. If the acknowledgement signal is not sent back, that communication data is retransmitted. In a case where it is determined that the communication data indicates a second data attribute in the transmitter, that communication data is transmitted and an acknowledgement signal is requested to be sent back according to an allowable number of retransmissions corresponding to the second data attribute. And that communication data is retransmitted in accordance with the allowable number of retransmissions and presence or absence of the acknowledgement signal sent back. The allowable number of retransmissions corresponding to the second data attribute is smaller than that corresponding to the first data attribute.

### BACKGROUND OF THE INVENTION

1. Field of the Invention

The present invention relates to a transmitting and receiving system, transmitting equipment, and a transmitting method, by which communication data sets having different priorities in communications are exchanged.

2. Description of the Related Art

In a conventional transmitting and receiving system (disclosed in Japanese Laid-Open Publication No. 2004-64271, for example), the transmitter is provided with a means for determining whether data to be transmitted is data (priority data) that requires retransmission processing or data (non-priority data) that does not require retransmission processing, so as to efficiently transmit video data and audio data through a transmission path, such as radio, whose reliability is not so high and whose transmission capacity is limited. In this transmitting and receiving system, if transmit data is data that does not require retransmission processing, the transmit data contains information indicating that no retransmission processing is necessary. Therefore, when the receiver receives the transmit data that does not require retransmission processing, an ACK packet is sent from the receiver to the transmitter even if the transmission data contains an error. The ACK packet is a signal for confirming that the transmit data from the transmitter has been received by the receiver.

The conventional transmitting and receiving system will be briefly described with reference to FIG. 14.

A radio transmitter/receiver 92 packetizes video data output from a video data output device 91 and then transmits the generated packets. A flag is added to each packet to be transmitted, with the flag indicating whether or not successful receipt of that packet by the receiver is requested. A radio transmitter/receiver 93 receives the packets transmitted from the radio transmitter/receiver 92, reconstructs the video data from the received packets, and outputs the video data to a video data input device 94.

Also, after the receipt of each packet transmitted from the radio transmitter/receiver 92, the radio transmitter/receiver 93 (the receiver) sends back an ACK packet. To be specific, when the received packet is priority data (i.e., a packet which is requested to be successfully received by the receiver), the radio transmitter/receiver 93 performs error detection for the received packet. If no error is detected, an ACK packet is sent back. On the other hand, if an error is detected, no ACK packet is sent back. Also, when the received packet is non-priority data (i.e., a packet which is not requested to be successfully received by the receiver), the radio transmitter/receiver 93 sends back an ACK packet without performing error detection for the received packet.

After the receipt of the ACK packet from the radio transmitter/receiver 93, the radio transmitter/receiver 92 (the transmitter) recognizes the receiver's receipt of the transmitted packet and then transmits a next packet. If the radio transmitter/receiver 92 does not receive the ACK packet within a predetermined length of time, the radio transmitter/receiver 92 recognizes that the transmitted packed was not received by the receiver, and then retransmits the same packet.

With reference to FIG. 15, a description will be made of a communication sequence in the conventional transmitting and receiving system shown in FIG. 14.

Data packets A-1 to A-K are packets (priority data) that are requested to be received successfully. As in the case of the data packet A-K, when an error has been detected in the receiver (the radio transmitter/receiver 93), i.e., when a packed has failed to be received, no ACK packet will be sent back, such that the transmitter retransmits the same packet.

Data packets B-1 to B-M are packets (non-priority data) that are not requested to be received successfully. As in the case of the data packet B-2, even if a packet has failed to be received due to, e.g., an error occurring in the receiver (the radio transmitter/receiver 93), an ACK packet is sent back, such that the transmitter does not retransmit the same packet.

As described above, in the conventional transmitting and receiving system, when data (priority data) that is requested to be successfully received by the receiver is transmitted, an ACK packet is sent back according to error detection result, and when data (non-priority data) that is not requested to be successfully received by the receiver is transmitted, an ACK packet is sent back without performing error detection. And upon receipt of the ACK packet, the transmitter transmits a packet that is next to be transmitted.

### SUMMARY OF THE INVENTION

However, even in the case where a packed transmitted by the transmitter is non-priority data, if there is no ACK packet sent back, the transmitter retransmits that packet. For example, in a case where a packet loss occurs, the receiver cannot receive the packet from the transmitter and hence cannot send back an ACK packet. In this case, even if the packet transmitted from the transmitter is non-priority data, the transmitter retransmits the non-priority data that is not requested to be received successfully. If such retransmission of non-priority data occurs frequently, transmission of priority data is delayed to cause a decrease in communication efficiency.

It is therefore an object of the present invention to improve communication efficiency by transmitting priority data more preferentially.

A principal aspect of the present invention is a transmitting and receiving system for exchanging, between a transmitter and a receiver, communication data. The communication data indicates either a first data attribute or a second data attribute. The second data attribute has a lower priority in communications than the first data attribute. The transmitter includes a data input section, a first analysis section, and a first transmitting section. The data input section receives the communication data. The first analysis section determines a data attribute of the communication data received by the data input section. In the first transmitting section, an allowable number of retransmissions for communication data indicating the second data attribute is limited. If the first analysis section determines that the communication data indicates the first data attribute, the first transmitting section transmits that communication data and requests that an acknowledgement signal be sent back. And if the first analysis section determines that the communication data indicates the second data attribute, the first transmitting section transmits that communication data and requests that the acknowledgement signal be sent back according to the allowable number of retransmissions. The receiver includes a receiving section, a second analysis section, and a second transmitting section. The receiving section receives the communication data from the transmitter. When the receiving section receives the communication data, the second analysis section determines whether or not an acknowledgement signal for that communication data needs to be sent back. If the second analysis section determines that the acknowledgement signal needs to be sent back, the second transmitting section sends back the acknowledgement signal. Where the first transmitting section transmits the communication data indicating the first data attribute, if the acknowledgement signal is not sent back, the first transmitting section retransmits that communication data. Where the first transmitting section transmits the communication data indicating the second data attribute, the first transmitting section retransmits that communication data in accordance with the allowable number of retransmissions and presence or absence of the acknowledgement signal sent back. The allowable number of retransmissions for the communication data indicating the second data attribute is smaller than that for the communication data indicating the first data attribute.

In the above transmitting and receiving system, communication data (priority data) indicating the first data attribute is retransmitted until an acknowledgement signal is sent back, while communication data (non-priority data) indicating the second data attribute is retransmitted only a limited number of times. In this manner, since the priority data is transmitted preferentially, it is possible to suppress a decrease in communication efficiency that would be otherwise caused by failure in transmission of the non-priority data, whereby the communication efficiency is improved.

When the first analysis section determines that the communication data indicates the first data attribute, the first transmitting section preferably transmits that communication data and requests that the acknowledgement signal be sent back. And when the first analysis section determines that the communication data indicates the second data attribute, the first transmitting section preferably transmits that communication data without requesting that the acknowledgement signal be sent back. Where the first transmitting section transmits the communication data indicating the first data attribute, if the acknowledgement signal is not sent back, the first transmitting section preferably retransmits that communication data. And where the first transmitting section transmits the communication data indicating the second data attribute, the first transmitting section preferably does not retransmit that communication data.

In the above transmitting and receiving system, the priority data is retransmitted in accordance with the presence or absence of the acknowledgement signal sent back, but no acknowledgement signal is sent back for the non-priority data and the non-priority data is thus not retransmitted. For example, even if a packet loss occurs in transmitting non-priority data, that non-priority data is not retransmitted. In this manner, since the priority data is transmitted preferentially, it is possible to suppress a decrease in communication efficiency that would be otherwise caused by failure in transmission of the non-priority data, whereby the communication efficiency is improved.

The first transmitting section preferably transmits the communication data received by the data input section and requests that the acknowledgement signal be sent back. If the acknowledgement signal for the communication data is not sent back, the first transmitting section preferably retransmits that communication data. But in a case in which that communication data indicates the first data attribute, if the number of times that communication data has been retransmitted exceeds M (where M is an integer equal to or greater than 2), the first transmitting section preferably discontinues the retransmission of that communication data. And in a case in which that communication data indicates the second data attribute, if the number of times that communication data has been retransmitted exceeds N (where N is an integer equal to or greater than 1 but equal to or smaller than M), the first transmitting section preferably discontinues the retransmission of that communication data.

In the above transmitting and receiving system, the allowable number of retransmissions for the priority data and the allowable number of retransmissions for the non-priority data are both limited. And the allowable number (N) of retransmissions for the non-priority data is smaller than the allowable number (M) of retransmissions for the priority data. Consequently, the priority data is transmitted preferentially, whereby it is possible to suppress a decrease in communication efficiency that would be otherwise caused by failure in transmission of the non-priority data. In addition, since the allowable number of retransmissions for the priority data is also limited, real-time transmission of the communication data is ensured, whereby the communication efficiency is improved further.

After the discontinuation of the retransmission of the communication data indicating the second data attribute, if communication data that is next to be transmitted indicates the second data attribute and that communication data relates to the communication data the retransmission of which was discontinued, the first transmitting section preferably does not transmit that communication data indicating the second data attribute, and if the communication data that is next to be transmitted indicates the first data attribute, the first transmitting section preferably transmits that communication data indicating the first data attribute.

In the above transmitting and receiving system, the communication data relating to the non-priority data having a low priority is not transmitted, so that the priority data is transmitted more preferentially, thereby further improving the communication efficiency.

The transmitter preferably further includes a measurement section for measuring a time period between the receipt of the communication data by the data input section and completion of transmission of that communication data by the first transmitting section. In a case in which the time period measured by the measuring section exceeds a predetermined time period, if communication data that is next to be transmitted indicates the second data attribute, the first transmitting section preferably does not transmit that communication data indicating the second data attribute, and if the communication data that is next to be transmitted indicates the first data attribute, the first transmitting section preferably transmits that communication data indicating the first data attribute.

In the above transmitting and receiving system, if delay time exceeds the predetermined time period, transmission of the non-priority data is cancelled preferentially. On the other hand, even in the case in which the delay time exceeds the predetermined time period, it is possible to avoid cancellation of transmission of the priority data. This allows the priority data to be transmitted more preferentially, thereby further improving the communication efficiency.

When the first transmitting section transmits the communication data indicating the first data attribute, the first transmitting section preferably transmits that communication data at a first transmission rate, and when the first transmitting section transmits the communication data indicating the second data attribute, the first transmitting section preferably transmits that communication data at a second transmission rate, which is faster than the first transmission rate.

In the above transmitting and receiving system, the priority data is more likely to be received successfully, while the non-priority data is transmitted faster. This enables the priority data to be transmitted more preferentially, thereby further improving the communication efficiency.

Another principal aspect of the present invention is a transmitter for transmitting communication data and receiving an acknowledgement signal from a receiver. The communication data indicates either a first data attribute or a second data attribute having a lower priority in communications than the first data attribute. The transmitter includes: a data input section, an analysis section, and a transmitting section. The data input section receives the communication data. The analysis section determines a data attribute of the communication data received by the data input section. In the transmitting section, an allowable number of retransmissions for communication data indicating the second data attribute is limited. If the analysis section determines that the communication data indicates the first data attribute, the transmitting section transmits that communication data and requests that an acknowledgement signal be sent back, and if the analysis section determines that the communication data indicates the second data attribute, the transmitting section transmits that communication data and requests that the acknowledgement signal be sent back according to the allowable number of retransmissions. Where the transmitting section transmits the communication data indicating the first data attribute, if the acknowledgement signal is not sent back, the transmitting section retransmits that communication data. And where the transmitting section transmits the communication data indicating the second data attribute, the transmitting section retransmits that communication data in accordance with the allowable number of retransmissions and presence or absence of the acknowledgement signal sent back. The allowable number of retransmissions for the communication data indicating the second data attribute is smaller than that for the communication data indicating the first data attribute.

In another principal aspect of the present invention, a transmitting method is carried out by a transmitter. The transmitter receives communication data indicating either a first data attribute or a second data attribute having a lower priority in communications than the first data attribute and receives an acknowledgement signal from a receiver. The transmitting method includes the steps of (a) to (c). In the step (a), a data attribute of the communication data received by the transmitter is determined. In the step (b), if it is determined in the step (a) that the communication data indicates the first data attribute, that communication data is transmitted and an acknowledgement signal for acknowledging receipt of the transmitted communication data is requested to be sent back. And in the step (b), if it is determined in the step (a) that the communication data indicates the second data attribute, that communication data is transmitted and the acknowledgement signal is requested to be sent back according to an allowable number of retransmissions for the communication data indicating the second data attribute. The step (c) is the step of, where the communication data indicating the first data attribute is transmitted in the step (b), if the acknowledgement signal is not sent back, retransmitting that communication data, and where the communication data indicating the second data attribute is transmitted in the step (b), retransmitting that communication data in accordance with the allowable number of retransmissions and presence or absence of the acknowledgement signal sent back. The allowable number of retransmissions for the communication data indicating the second data attribute is smaller than that for the communication data indicating the first data attribute.

### BRIEF DESCRIPTION OF THE DRAWINGS

FIG. 1 is a block diagram illustrating the entire structure of a transmitting and receiving system according to a first embodiment of the present invention.

FIG. 2 is a block diagram illustrating the internal structure of radio transmitters/receivers shown in FIG. 1.

FIG. 3 illustrates a picture structure in MPEG2 video.

FIG. 4 illustrates packet data on a transmission path.

FIG. 5 is a view for explaining a communication sequence in the transmitting and receiving system shown in FIG. 1.

FIG. 6 is a view for explaining a communication sequence in a transmitting and receiving system according to a second embodiment of the present invention.

FIG. 7 is a view for explaining a modified example of the communication sequence in the transmitting and receiving system according to the second embodiment of the present invention.

FIG. 8 is a view for explaining a communication sequence in a transmitting and receiving system according to a third embodiment of the present invention.

FIG. 9 is a view for explaining a communication sequence in a transmitting and receiving system according to a fourth embodiment of the present invention.

FIG. 10 is a block diagram illustrating the entire structure of a transmitting and receiving system according to a fifth embodiment of the present invention.

FIG. 11 is a block diagram illustrating the internal structure of transmitters/receivers shown in FIG. 10.

FIG. 12 illustrates the configurations of MPEG-TS packets.

FIG. 13 is a view for explaining a communication sequence in the transmitting and receiving system shown in FIG. 10.

FIG. 14 is a block diagram illustrating the entire structure of a conventional transmitting and receiving system.

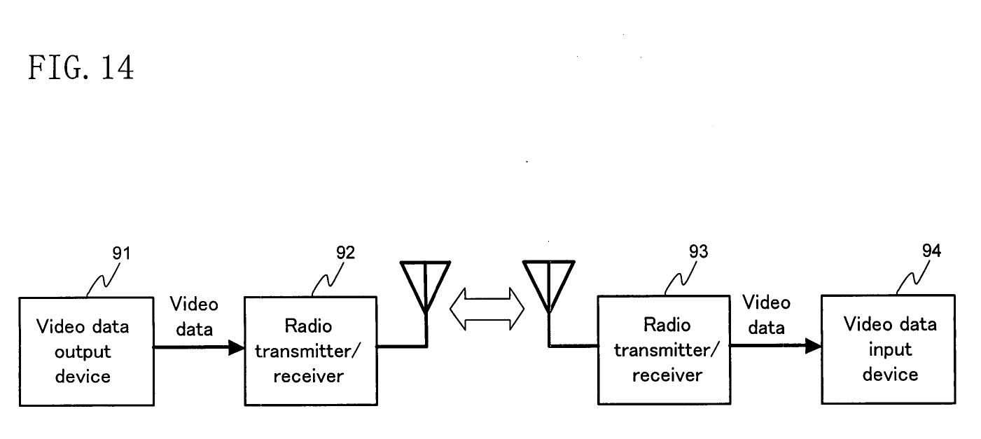

FIG. 15 is a view for explaining a communication sequence in the conventional transmitting and receiving system.

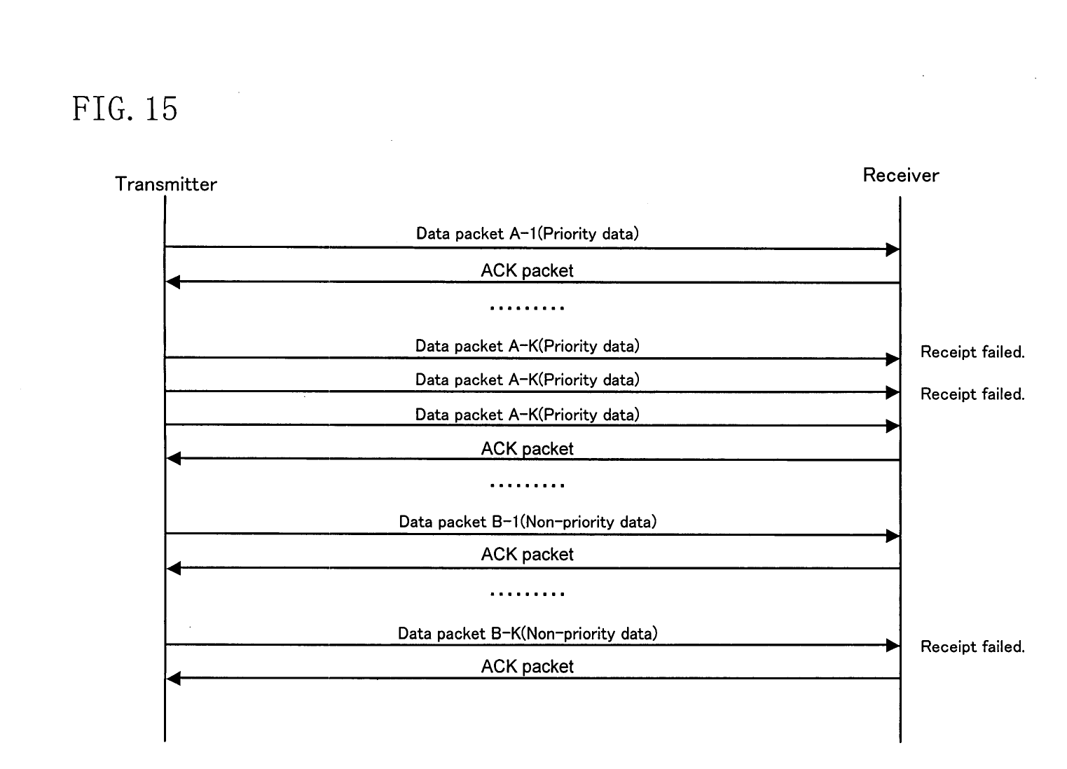

### DETAILED DESCRIPTION OF THE INVENTION

Hereinafter, embodiments of the present invention will be described in detail with reference to the accompanying drawings. In the drawings, the same or equivalent members are identified by the same reference numerals and the description thereof will not be repeated herein.

(First Embodiment)

<Entire Structure>

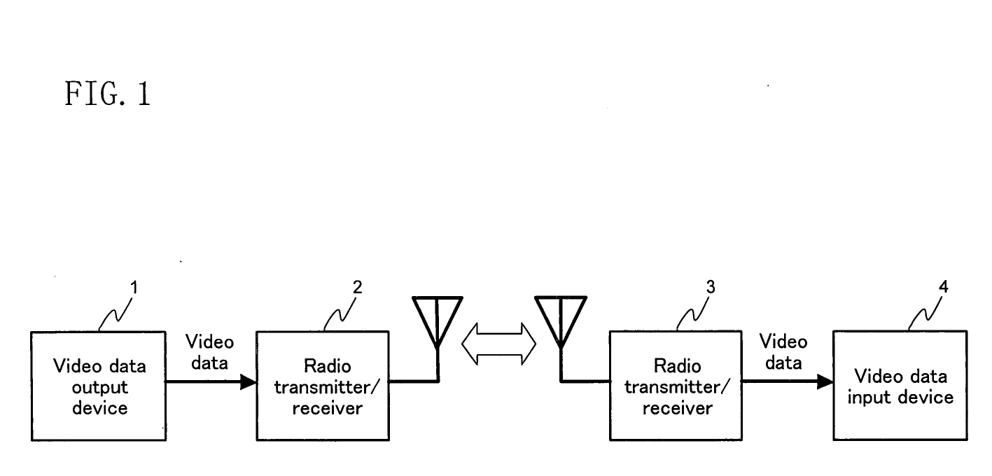

FIG. 1 illustrates the entire structure of a transmitting and receiving system according to a first embodiment of the present invention. The transmitting and receiving system includes a video data output device 1, radio transmitters/receivers 2 and 3, and a video data input device 4. The transmitting and receiving system transmits video data from the transmitter to the receiver.

The video data output device 1 is a video recorder, for example, and outputs video data to the radio transmitter/receiver 2. The radio transmitter/receiver 2 receives the video data from the video data output device .1 and transmits the received video data to the radio transmitter/receiver 3 via a radio transmission path. The radio transmitter/receiver 3 outputs the video data received through the radio transmission path to the video data input device 4. The video data input device 4, which is a television, for example, receives the video data from the radio transmitter/receiver 3 and provides the user with the video.

When the radio transmitter/receiver 2 transmits a packet that is “priority data”, the radio transmitter/receiver 2 requests that an ACK packet be sent back. And when the radio transmitter/receiver 2 transmits a packet that is “non-priority data”, the radio transmitter/receiver 2 does not request that an ACK packet be sent back. An ACK packet is a signal for confirming that data transmitted from the transmitter has been received by the receiver. That is, the radio transmitter/receiver 3 sends back an ACK packet if the received packet is “priority data”, but does not send back an ACK packet if the received packet is “non-priority data”.

<Internal Structure of the Radio Transmitters/receivers>

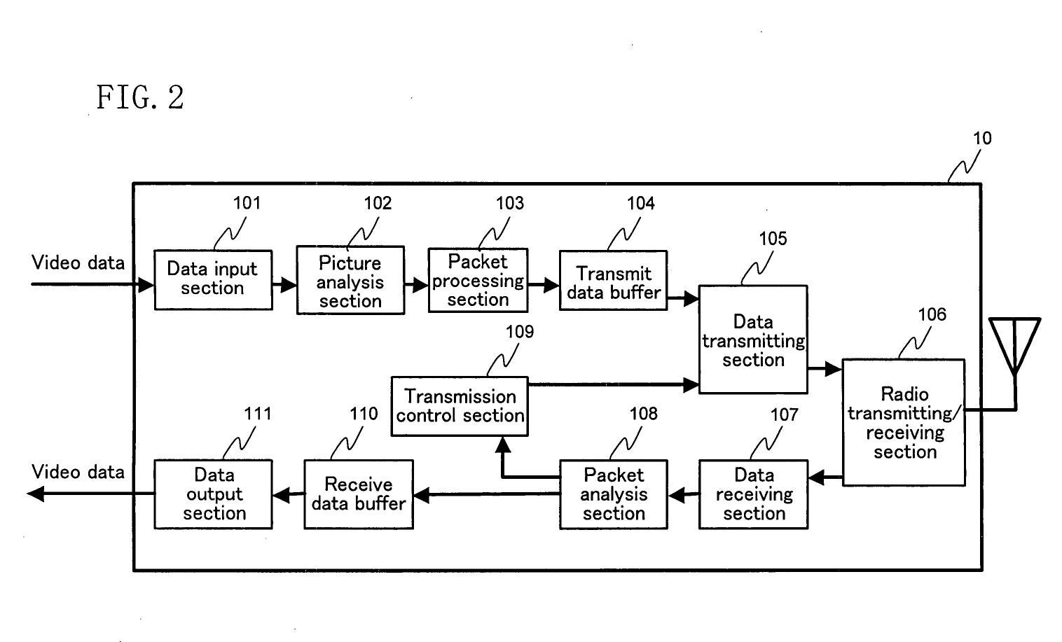

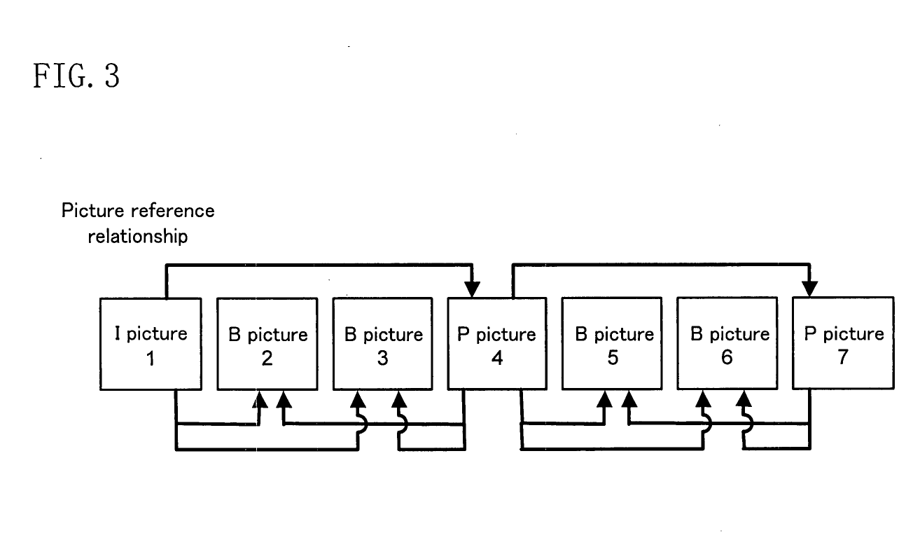

FIG. 2 illustrates the internal structure of the radio transmitters/receivers 2 and 3 shown in FIG. 1. Since the radio transmitters/receivers 2 and 3 have the same internal structure, they are represented by a radio transmitter/receiver 10 in FIG. 3.

The radio transmitter/receiver 10 includes a data input section 101, a picture analysis section 102, a packet processing section 103, a transmit data buffer 104, a data transmitting section 105, a radio transmitting/receiving section 106, a data receiving section 107, a packet analysis section 108, a transmission control section 109, a receive data buffer 110, and a data output section 111.

[As a Transmitter]

First, a description will be made of a case in which the radio transmitter/receiver 10 shown in FIG. 2 is used as a transmitter (i.e., the radio transmitter/receiver 2 shown in FIG. 1).

The data input section 101 receives video data (MPEG video data) from the video data output device 1.

The picture analysis section 102 analyzes the NPEG video data from the data input section 101 and determines whether the video data is I picture data, P picture data, or B picture data. This determination can be made by analyzing the picture header described in ITU-T H. 262. The picture analysis section 102 also divides (packetizes) the MPEG video data input by the data input section 101 in accordance with a packet length transmitted by radio.

The packet processing section 103 refers to the result of the picture type determination made by the picture analysis section 102 and adds identification information to each packet generated by the picture analysis section 102. The identification information indicates whether the packet is “priority data” or “non-priority data”. In this process, the packet processing section 103 adds identification information indicating “priority data” to each packet containing I picture data and to each packet containing P picture data, while adding identification information indicating “non-priority data” to each packet containing B picture data. The identification information indicating “priority data” is, for example, a flag indicating that the packet is requested to be successfully received by the receiver, while the identification information indicating “non-priority data” is, for example, a flag indicating that the packet is not requested to be successfully received by the receiver.

The transmit data buffer 104 stores therein the packets having the identification information added by the packet processing section 103.

The data transmitting section 105 transmits each packet stored in the transmit data buffer 104 through the radio transmitting/receiving section 106.

The radio transmitting/receiving section 106 receives an ACK packet sent back from the receiver (the radio transmitter/receiver 3).

The data receiving section 107 receives the ACK packet received by the radio transmitting/receiving section 106.

The packet analysis section 108 analyzes the packet input by the data receiving section 107. As a result of the analysis, if it is determined that the received packet is an “ACK packet”, the packet analysis section 108 notifies the transmission control section 109 of the receipt of the ACK packet.

The transmission control section 109 refers to the identification information added to the packet transmitted by the data transmitting section 105 and determines the type of the packet (i.e., whether the packet is “priority data” or “non-priority data”). In a case where the transmission control section 109 has determined that the packet transmitted by the data transmitting section 105 is “priority data”, if the transmission control section 109 receives a notification of receipt of an ACK packet from the packet analysis section 108 within a specified length of time after the transmission of the packet, the transmission control section 109 recognizes that the packet transmitted by the data transmitting section 105 was received by the receiver and therefore deletes the packet from the transmit data buffer 104, while making the data transmitting section 105 transmit a next packet. On the other hand, if the transmission control section 109 does not receive a notification of receipt of an ACK packet within the specified length of time, the transmission control section 109 recognizes that the packet transmitted by the data transmitting section 105 was not received by the receiver (i.e., the packet failed to be received) and makes the data transmitting section 105 retransmit the same packet. In a case where the transmission control section 109 has determined that the packet transmitted by the data transmitting section 105 is “non-priority data”, the transmission control section 109 makes the data transmitting section 105 transmit the next packet regardless of the presence or absence of the notification of the receipt of the ACK packet.

[As a Receiver]

Next, a description will be made of a case in which the radio transmitter/receiver 10 shown in FIG. 2 is used as a receiver (i.e., the radio transmitter/receiver 3 shown in FIG. 1).

The radio transmitting/receiving section 106 receives a packet from the transmitter (the radio transmitter/receiver 2).

The data receiving section 107 receives the packet received by the radio transmitting/receiving section 106.

The packet analysis section 108 analyzes the packet input by the data receiving section 107. In analyzing the packet, the packet analysis section 108 refers to the identification information added to the packet so as to determine whether the packet is “priority data (the packet that is requested to be received successfully)” or “non-priority data (the packet that is not requested to be received successfully)”. As a result of the determination, if it has been determined that the packet is “priority data”, the packet analysis section 108 performs error detection for the packet by using an error control code in the packet. If no error is detected, the packet analysis section 108 instructs the transmission control section 109 to transmit an ACK packet. If an error is detected, the packet analysis section 108 does not instruct the transmission control section 109 to transmit an ACK packet.

As a result of the analysis of the packet input by the data receiving section 107, if the packet analysis section 108 has determined that the packet is “non-priority data”, the packet analysis section 108 outputs the packet to the receive data buffer 110 without performing error detection for the packet. At this time, the packet analysis section 108 does not instruct the transmission control section 109 to transmit an ACK packet.

After receiving the instruction to send back an ACK packet from the packet analysis section 108, the transmission control section 109 makes the data transmitting section 105 send back the ACK packet. The ACK packet allows the transmitter (the radio transmitter/receiver 2) to recognize that the packet was successfully received by the receiver (the radio transmitter/receiver 3), such that the transmitter does not retransmit the same packet. On the other hand, when not instructed by the packet analysis section 108 to send back an ACK packet, the transmission control section 109 does not make the data transmitting section 105 send back an ACK packet. By the absence of an ACK packet, the transmitter recognizes that the packet (priority data) was not successfully received by the receiver and therefore retransmits the same packet.

The receive data buffer 110 stores each packet input from the packet analysis section 108.

The data output section 111 reconstructs the video data from the packets stored in 10 the receive data buffer 110 and outputs the reconstructed video data to the video data input device 4.

<Video Data>

With reference to FIG. 3, a description will be made of the video data output from the video data output device 1. In this embodiment, it is assumed that the video data format is MPEG2 video data (ITU-T H. 262).

Pictures produced according to the MPEG2 standard include three kinds of pictures: I pictures, P pictures, and B pictures. An I picture can be decoded only by using data contained in that picture without referring to other pictures. A P picture is decoded by referring to an I picture or a P picture transmitted immediately before that P picture. A P picture contains data indicating the difference between the reference picture and that P picture. That is, when the receiver decodes a P picture, picture data in the preceding I or P picture is necessary. A B picture is decoded by referring to two pictures, which are the immediately preceding I or P picture and the immediately following I or P picture. A B picture contains data indicating the differences between the two reference pictures and that B picture. That is, when the receiver decodes a B picture, two picture data sets in the immediately preceding I or P picture and in the immediately following I or P picture are necessary.

<Packet Data>

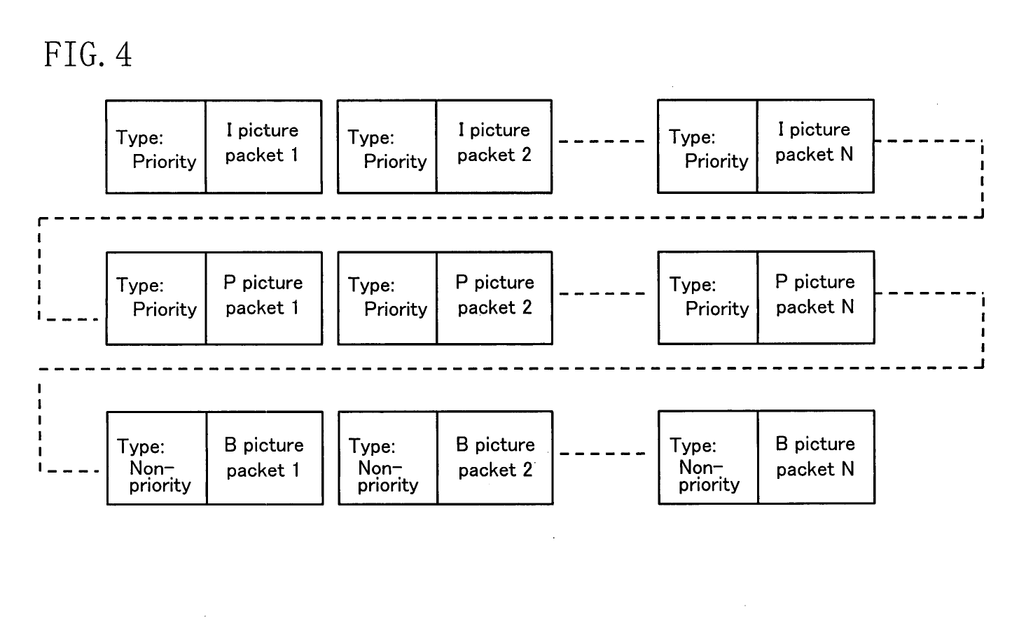

FIG. 4 illustrates an example of video data packetized by the picture analysis section 102.

Identification information indicating “priority data” is added to I picture data and P picture data, while identification information indicating “non-priority data” is added to B picture data. In this embodiment, the I picture data and the P picture data having the added identification information indicating “priority data” are requested to be successfully received by the receiver, and ACK packets are also requested to be sent back as acknowledgement of receipt thereof. On the other hand, the B picture data having the added identification information indicating “non-priority data” is not requested to be successfully received, and ACK packets are also not requested to be sent back as acknowledgement of receipt thereof.

<Communication Sequence>

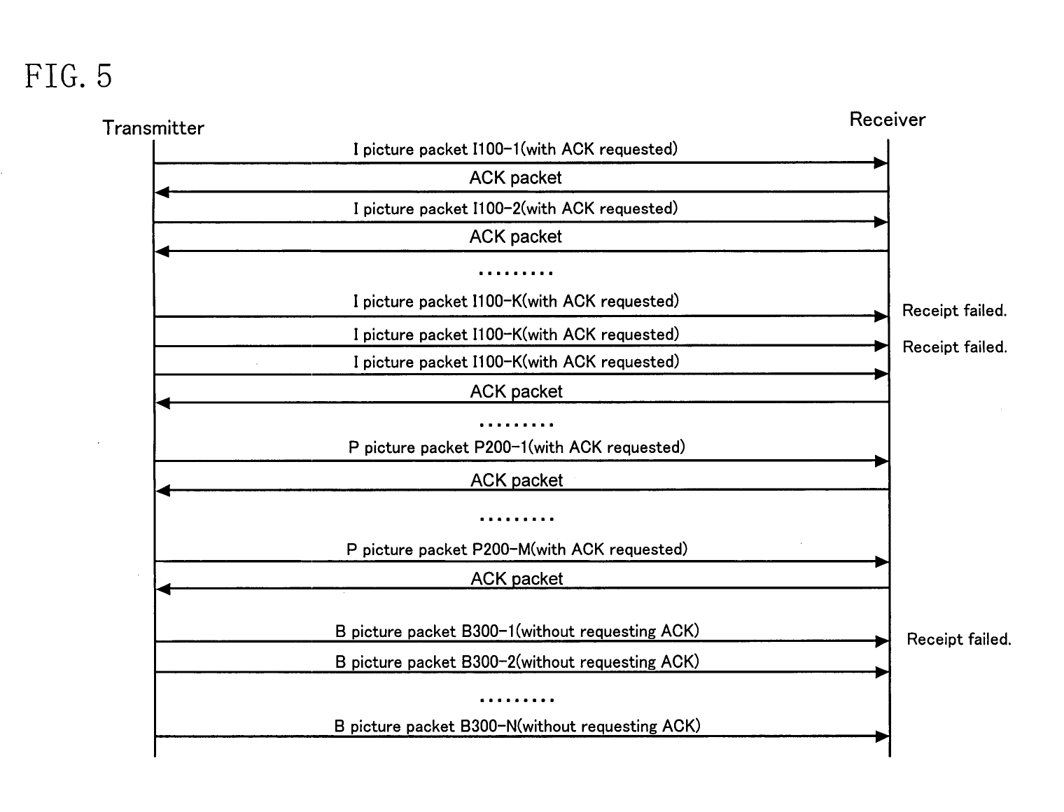

With reference to FIG. 5, operation of the transmitting and receiving system shown in FIG. 1 will be described.

[Priority Data]

When I picture packets I100-1 to I100-K (where K is a natural number) and P picture packets P200-1 to P200-M (where M is a natural number), each of which is priority data, are transmitted, it is requested that ACK packets be sent back as acknowledgement of receipt of these packets (these packets are transmitted with ACK packets being requested).

Next, if the receiver successfully receives priority data, such as the I picture packet I100-1, the packet analysis section 108 instructs the transmission control section 109 to send back an ACK packet.

Then, if the transmitter receives the ACK packet (i.e., the ACK packet as acknowledgement of receipt of the I picture packet I100-1) sent back from the receiver, the transmission control section 109 deletes the I picture packet I100-1 from the transmit data buffer 104. The transmission control section 109 then makes the data transmitting section 105 transmit the I picture packet I100-2.

As in the case of the I picture packet I100-K, when a packet has failed to be received by the receiver due to the packet loss, an error or the like, the packet analysis section 108 in the receiver does not instruct the transmission control section 109 to send an ACK packet. In this case, in the transmitter, the transmission control section 109 does not receive a notification of receipt of an ACK packet and therefore makes the data transmitting section 105 retransmit the packet (I picture packet 1100-K) that has failed to be received.

[Non-priority Data]

When packets B300-1 to B300-N (where N is a natural number) that are non-priority data are transmitted, ACK packets are not requested to be sent back as acknowledgement of receipt of these packets (these packets are transmitted without requesting ACK packets).

In the receiver, the packet analysis section 108 does not instruct the transmission control section 109 to send back an ACK packet both in the case in which the receiver has failed to receive a packet due to the packet loss, an error, or the like (for example, in the case of the B picture packet B300-1), and in the case in which the receiver has successfully received a packet (for example, in the case of the B picture packet B300-2).

Although no ACK packet is sent back, the transmission control section 109 in the transmitter recognizes that the data transmitted by the data transmitting section 105 is “non-priority data” and therefore does not retransmit the packet (the B picture packet B300-1) that has failed to be received. In this manner, the transmitter does not retransmit “non-priority data” irrespective of the present or absence of an ACK packet sent back.

<Influence of Picture Type on Moving Picture>

When I and P pictures were not successfully transmitted or received, the P and B pictures that refer to those pictures cannot also be decoded correctly to cause block noise and the like, thereby significantly affecting the video presented to viewers. On the other hand, when B pictures were not successfully transmitted or received and the data was thus lost, it is possible to minimize adverse effects on the viewers by repeatedly playing back data in the preceding picture and the like.

<Effects>

As described above, I pictures and P pictures, which are priority data, are retransmitted until they are received successfully, so that the data transmission thereof is carried out without fail, while B pictures, which are “non-priority data”, are not retransmitted. In this manner, the priority data is transmitted preferentially, whereby it is possible to prevent a decrease in communication efficiency in the entire communications that would be otherwise caused by failure in transmission of the non-priority data. In addition, since no ACK packets are sent back as acknowledgement of receipt of the non-priority data, the non-priority data is not retransmitted even if a packet loss occurs in transmitting the non-priority data. Consequently, as compared to the conventional system, the priority data can be transmitted more preferentially, thereby improving the communication efficiency. This enables natural video to be presented to the users through a transmission path, such as radio, whose reliability is low and whose transmission band is limited.

(Second Embodiment)

<Structure>

Although the entire structure of a transmitting and receiving system according to a second embodiment of the present invention is the same as that shown in FIG. 1, a packet analysis section 108 and a transmission control section 109 carry out different processing.

A radio transmitter/receiver 2 requests that an ACK packet be sent back regardless of whether the packet to be transmitted is “priority data” or “non-priority data” . That is, a radio transmitter/receiver 3 sends back an ACK packet regardless of whether the received packet is “priority data” or “non-priority data”. In this embodiment, a packet with added identification information indicating “priority data” is requested to be successfully received by the receiver, and an ACK packet is also requested to be sent back as acknowledgement of receipt of that packet. On the other hand, a packet indicating “non-priority data” is not requested to be successfully received, but an ACK packet is requested to be sent back.

[As a Receiver]

After determining that a packet from a data receiving section 107 is “priority data”, the packet analysis section 108 performs error detection for the packet. If no error is detected, the packet analysis section 108 instructs the transmission control section 109 to send back an ACK packet. And if an error is detected, the packet analysis section 108 does not instruct the transmission control section 109 to send back an ACK packet.

When the packet from the data receiving section 107 is “non-priority data”, the packet analysis section 108 outputs the packet to a receive data buffer without performing error detection. At this time, the packet analysis section 108 instructs the transmission control section 109 to send back an ACK packet.

[As a Transmitter]

Upon receipt of an ACK packet from the data receiving section 107, the packet analysis section 108 makes a notification of the receipt of the ACK packet.

In the transmission control section 109, the allowable number of retransmissions corresponding to priority data and the allowable number of retransmissions corresponding to non-priority data have been set. The allowable number of retransmissions corresponding to the non-priority data is smaller than the allowable number of retransmissions corresponding to the priority data.

If the transmission control section 109 does not receive the notification of the receipt of the ACK packet before a measurement time reaches a certain time, the transmission control section 109 determines whether or not the number of times the packet has been retransmitted has reached the allowable number of retransmissions corresponding to the attribute of that packet. If the number of times the packet has been retransmitted has not reached the allowable number of retransmissions, the transmission control section 109 makes the data transmitting section 105 retransmit that packet. If it has reached the allowable number of retransmissions, the transmission control section 109 deletes that packet from the transmit data buffer 104 without making the data transmitting section 105 retransmit that packet. And the transmission control section 109 makes the data transmitting section 105 transmit a packet next to be transmitted.

<Communication Sequence>

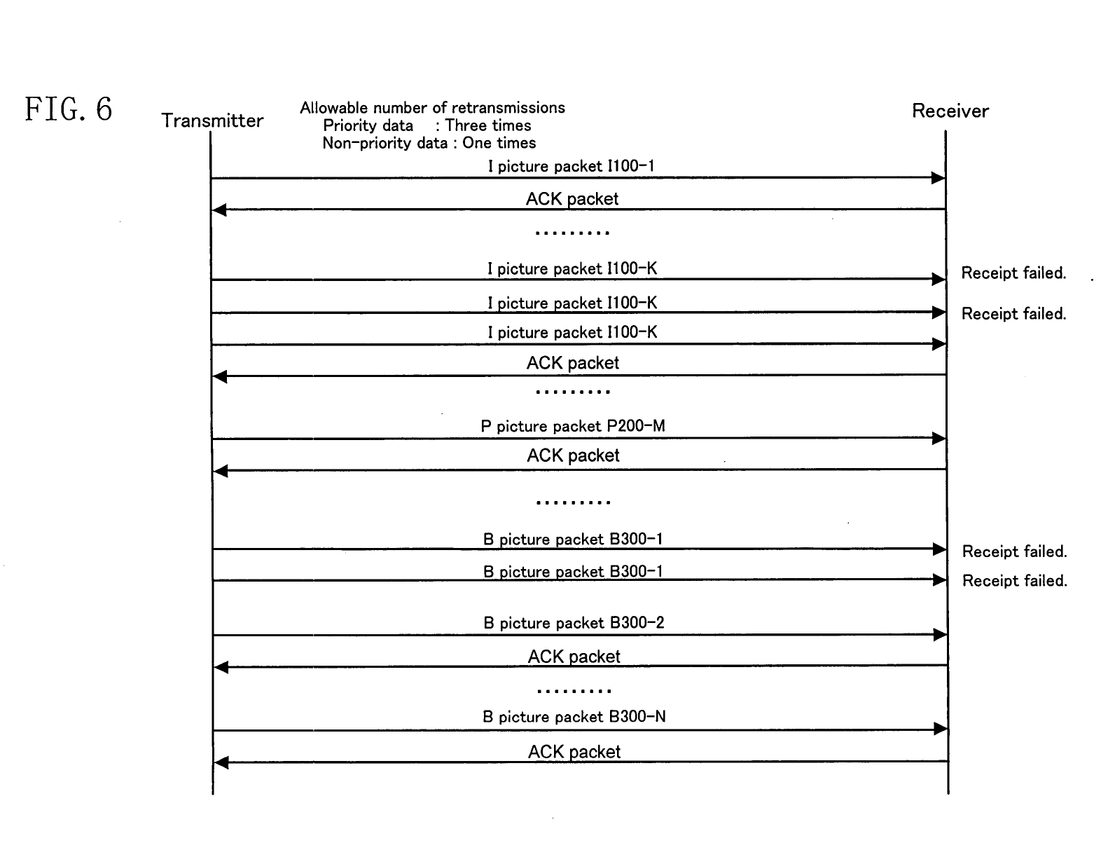

With reference to FIG. 6, operation of the transmitting and receiving system according to this embodiment will be described. In this embodiment, it is assumed that the allowable number of retransmissions is “three” for priority data (I pictures and P pictures), while the allowable number of retransmissions is “one” for non-priority data (B pictures).

[Priority Data]

As in the case of an I picture packet I100-K, if the receiver fails to receive a packet twice, the transmission control section 109 in the transmitter forces the data transmitting section 105 to make a third retransmission of the packet, because the allowable number of retransmissions is set to “three” for the priority data. In this way, in the transmitter, the data transmitting section 105 retransmits the packet without deleting that packet from the transmit data buffer 104 until the number of retransmissions of that packet reaches the allowable number of retransmissions.

On the other hand, as in the case of a P picture packet P200-M, if the packet analysis section 108 in the receiver does not detect an error in a received packet, the packet analysis section 108 instructs the transmission control section 109 to send an ACK packet. In the transmitter, when the transmission control section 109 is notified by the packet analysis section 108 of the receipt of the ACK packet, the transmission control section 109 deletes the transmitted packet (the P picture packet P200-M) from the transmit data buffer 104 and makes the data transmitting section 105 transmit a packet next to be transmitted.

[Non-priority Data]

As in the case of a B picture packet B300-1, if the receiver fails to receive a packet twice, the transmission control section 109 in the transmitter deletes the B picture packet B300-1 from the transmit data buffer 104 without making the data transmitting section 105 retransmit the B picture packet B300-1, because the allowable number of retransmissions is set to “one” for the non-priority data. And the transmission control section 109 makes the data transmitting section 105 transmit a B picture packet B300-2 that is next to be transmitted. In this manner, in the transmitter, if the number of times a packet has been retransmitted reaches the allowable number of retransmissions, that packet is deleted from the transmit data buffer 104 without being retransmitted anymore. And the data transmitting section 105 transmits packet data that is next to be transmitted.

<Effects>

As described above, the allowable number of retransmissions for a B picture, which is non-priority data, is smaller than the allowable number of retransmissions for an I picture and a P picture, which are priority data. In this way, by setting the number of retransmissions of non-priority data smaller than that of priority data, the priority data is transmitted preferentially. This makes it possible to prevent a decrease in communication efficiency in the entire communications that would be otherwise caused by failure in transmission of the non-priority data, whereby the communication efficiency is improved. In addition, since the allowable number of retransmissions for the priority data is also limited, real-time transmission of the video data can be ensured. Consequently, it is possible to efficiently present natural video to viewers (users) within a limited transmission band.

Furthermore, priorities can be set more freely as compared to the first embodiment in which priorities are controlled according to the necessity for sending back an ACK packet. For example, when packets are transmitted by radio, the allowable number of retransmissions can be set for each packet in accordance with the state of the radio. More specifically, when the radio is in good condition or when the transmission band is sufficient, the allowable number of retransmissions may be set to “four” for I pictures and P pictures, while the allowable number of retransmissions may be set to “two” for B pictures. When the radio is in bad condition or when the transmission band is not sufficient, the allowable number of retransmissions may be set to “three” for the I pictures and the P pictures, while the allowable number of retransmissions may be set to “one” for the B pictures.

Moreover, it is possible to set two or more priority levels. For instance, different priorities can be assigned to I pictures, P pictures, and B pictures. To be specific, the allowable number of retransmissions may be set to “four” for the I pictures, “three” for the P pictures, and “two” for the B pictures.

<Modified Example of the Communication Sequence>

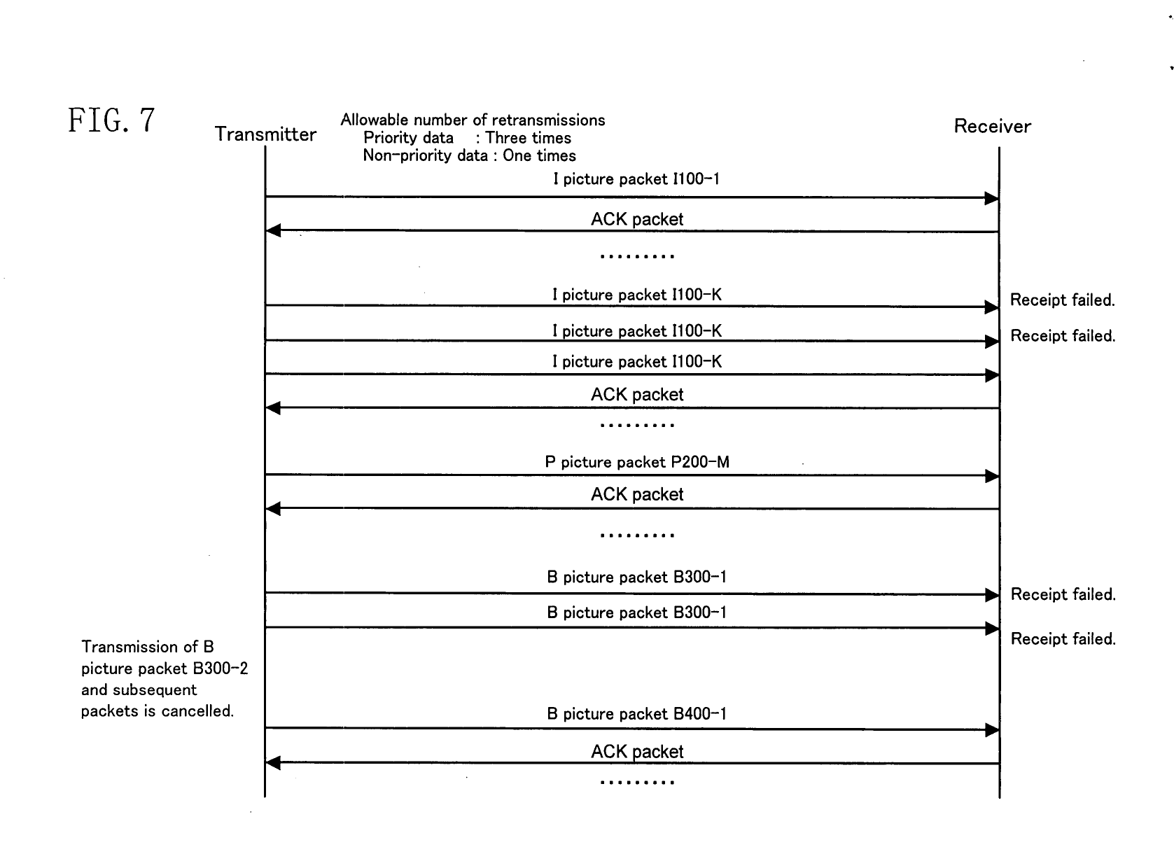

It should be noted that as shown in FIG. 7, transmission of picture packets relating to a picture packet whose retransmission was discontinued may also be cancelled. For example, if transmission of the B picture packet B300-1, which is part of a B picture B300, has failed, transmission of the B picture packets B300-2 to B300-N that relate to the same B picture B300 as the B picture packet B300-1 may be cancelled.

In this case, in the transmitter, the transmission control section 109 deletes the B picture packet B300-1 from the transmit data buffer 104 when the number of retransmissions of the B picture packet B300-1 reaches the allowable number of retransmissions therefor, and thereafter, also deletes the B picture packets B300-2 to B300-N that follows the B picture packet B300-1 from the transmit data buffer 104. As a result, the communication efficiency can be improved further.

(Third Embodiment)

In a video-data transmitting and receiving system, such as a security camera and the like, real-time playback of pictures may be required in the receiver. In such a case, delay time needs to be shortened. In this embodiment, priority control in which maximum allowable delay time is set will be discussed.

<Structure>

Although the entire structure of a transmitting and receiving system according to the third embodiment of the present invention is the same as that shown in FIG. 1, a packet analysis section 108 and a transmission control section 109 carry out different processing.

As in the second embodiment, a radio transmitter/receiver 2 requests that an ACK packet be sent back both in a case in which a packet to be transmitted is “priority data”, and in a case in which it is “non-priority data”. That is, a radio transmitter/receiver 3 sends back an ACK packet, irrespective of whether the received packet is “priority data” or “non-priority data”.

[As a Receiver]

As in the second embodiment, after determining that a packet from a data receiving section 107 is “priority data”, the packet analysis section 108 performs error detection for the packet. If no error is detected, the packet analysis section 108 instructs the transmission control section 109 to send back an ACK packet. And if an error is detected, the packet analysis section 108 does not instruct the transmission control section 109 to send back an ACK packet.

When the packet from the data receiving section 107 is “non-priority data”, the packet analysis section 108 outputs the packet to a receive data buffer 110 without performing error detection, as in the second embodiment. At this time, the packet analysis section 108 instructs the transmission control section 109 to send back an ACK packet.

[As a Transmitter]

The transmission control section 109 measures the time (the arrival time) at which each picture in video data is input into a data input section 101. The transmission control section 109 associates each packet generated by a packet processing section 103 with information (arrival time information) indicating arrival time corresponding to that packet. For example, the transmission control section 109 associates each packet generated by division of I picture data with time information indicating the time at which that I picture data was input into the data input section 101.

Upon receipt of an ACK packet from the data receiving section 107, the packet analysis section 108 makes a notification of the receipt of the ACK packet.

Maximum allowable delay time has been set in the transmission control section 109. The maximum allowable delay time corresponds to the length of time between the receipt of video data (a picture) by the data input section 101 and the completion of transmission of that picture.

After receiving the notification of the receipt of the ACK packet from the packet analysis section 108, the transmission control section 109 obtains the time information associated with the packet transmitted by the data transmitting section 105 and then calculates a delay time based on the arrival time indicated by the obtained time information and the current time (the time of the completion of the transmission). If the transmission control section 109 determines that the calculated delay time exceeds the maximum allowable delay time, the transmission control section 109 identifies the type (the data attribute) of a packet next to be transmitted. If the packet next to be transmitted is “priority data”, the transmission control section 109 makes the data transmitting section 105 transmit that packet next to be transmitted. If the packet next to be transmitted is “non-priority data” , the transmission control section 109 deletes that packet next to be transmitted without making the data transmitting section 105 transmit that packet.

<Communication Sequence>

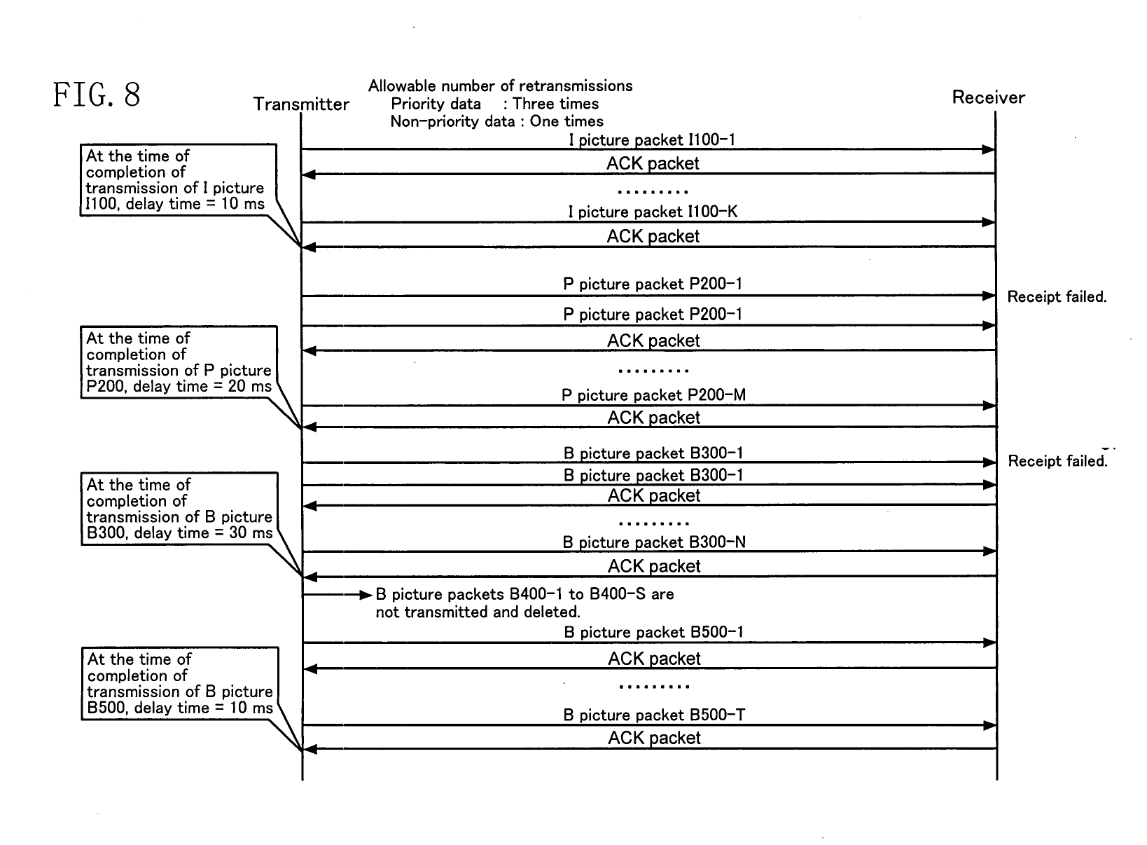

With reference to FIG. 8, operation of the transmitting and receiving system according to this embodiment will be described. In this embodiment, it is assumed that the maximum allowable delay time is “25 ms”. It is also assumed that as in the second embodiment, the allowable number of retransmissions is “three” for priority data (I pictures and P pictures), while the allowable number of retransmissions is “one” for non-priority data (B pictures).

First, in the transmitter, the data transmitting section 105 transmits I picture packets I100-1 to I100-K, which correspond to an “I picture I100”. It is assumed that the delay time calculated at the time when the transmission of the I picture packet I100-K was complete was “10 ms”. The more times picture packets are retransmitted, the longer the delay time will be.

Next, in the transmitter, the data transmitting section 105 transmits P picture packets P200-1 to P200-M, which correspond to a “P picture P200”. It is assumed that the delay time calculated at the time when the transmission of the P picture packet P200-M was complete was “20 ms”, because the picture packets were retransmitted many times due to a deteriorated condition in the radio transmission path.

Subsequently, in the transmitter, the data transmitting section 105 transmits B picture packets B300-1 to B300-N, which correspond to a “B picture B300”. It is assumed that the delay time calculated at the time when the transmission of the B picture packets was complete was “30 ms”, because the picture packets were retransmitted many times.

Since the delay time exceeds the maximum allowable delay time, the transmission control section 109 identifies the data attribute of the picture packet that is next to be transmitted. Since the packet next to be transmitted is a B picture packet B400-1 that corresponds to a “B picture B400”, the transmission control section 109 deletes the picture packet next to be transmitted from the transmit data buffer 104. It should be noted that in FIG. 8, not only the B picture packet B400-1 but also B picture packets B400-2 to B400-S (where S is a natural number) that correspond to the “B picture B400” are deleted.

Next, in the transmitter, the transmission control section 109 transmits B picture packets B500-1 to B500-T (where T is a natural number) that are to be transmitted following the deleted picture packets. Since the transmission of the B picture packets B400-1 to B400-S was cancelled, the delay time that is calculated when the transmission of the B picture packet B500-T is complete is decreased to “10 ms” as shown in FIG. 8.

<Effects>

As mentioned previously, if a delay time exceeds the maximum allowable delay time, transmission of non-priority data next to be transmitted is cancelled preferentially. And it is possible to avoid cancellation of transmission of priority data. Therefore, as compared with the conventional system, priority data can be transmitted more preferentially, allowing the communication efficiency to be improved. Accordingly, more natural moving pictures can be presented to users.

In the exemplary case described in this embodiment, the maximum allowable delay time is set in the transmitting and receiving system of the second embodiment, but may be set in the transmitting and receiving system of the first embodiment.

(Fourth Embodiment)

In some radio transmission systems, a plurality of transmission rates are realized. For instance, in IEEE802.11a using 5 GHz, eight transmission rates, which are 54 Mbps, 48 Mbps, 36 Mbps, 24 Mbps, 18 Mbps, 12 Mbps, 9 Mbps, and 6 Mbps, are realized. In this embodiment, it is assumed that a radio transmission system of this kind is used, and a description will be made of priority control in which a transmission rate is set for each data attribute.

<Structure>

Although the entire structure of a transmitting and receiving system according to the fourth embodiment of the present invention is the same as that shown in FIG. 1, a data transmitting section 105 and a transmission control section 109 carry out different processing.

In the transmission control section 109, a transmission rate corresponding to priority data (I pictures and P pictures) and a transmission rate corresponding to non-priority data (B pictures) have been set. The transmission rate corresponding to the non-priority data is faster than that corresponding to the priority data.

The transmission control section 109 determines the data attribute of a picture packet that is next to be transmitted by a data transmitting section 105 and then sets the transmission rate at which that picture packet next to be transmitted will be transmitted.

The data transmitting section 105 transmits that packet next to be transmitted, which is stored in a transmit data buffer, at the transmission rate set by the transmission control section 109. For example, when the packet next to be transmitted is “priority data” , the data transmitting section 105 transmits that packet at the transmission rate corresponding to the priority data.

<Communication Sequence>

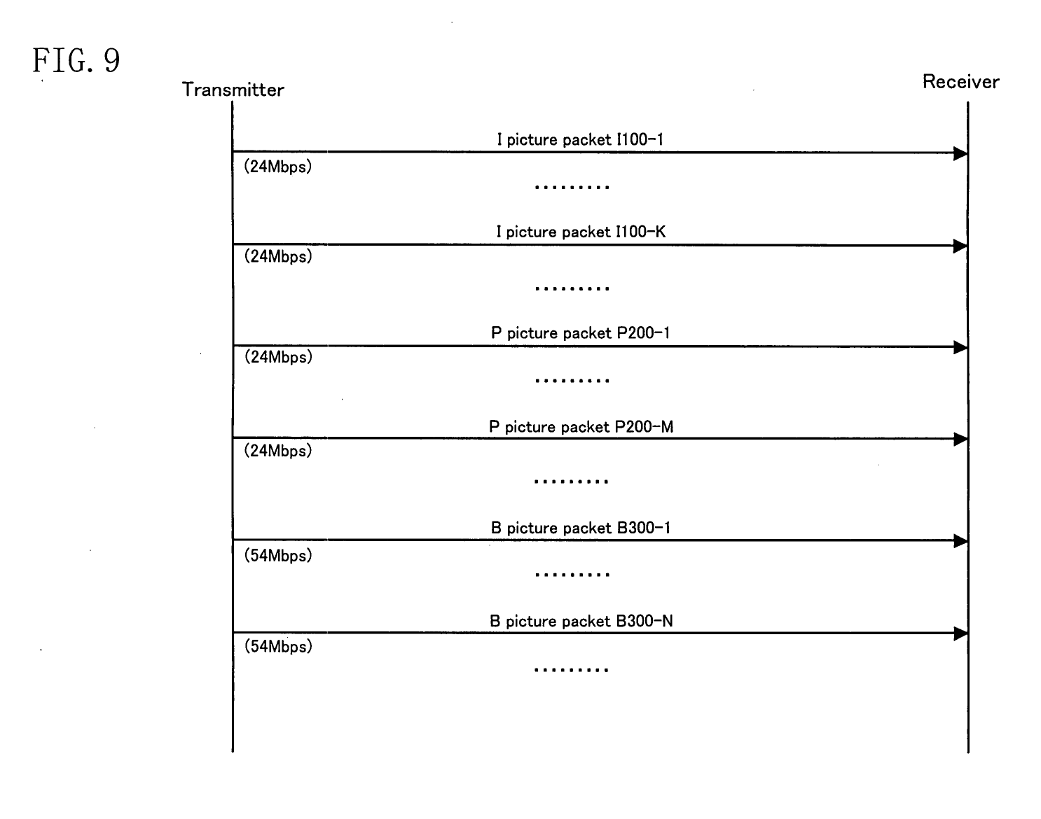

With reference to FIG. 9, operation of the transmitting and receiving system according to this embodiment will be described. In this embodiment, it is assumed that the transmission rate corresponding to the priority data is “24 Mbps”, while the transmission rate corresponding to the non-priority data is “54 Mbps”

[Priority Data]

In the transmitter, an I picture I100 (I picture packets I100-1 to I100-K) and a P picture P200 (P picture packets P200-1 to P200-M) are transmitted at a transmission rate of 24 Mbps.

[Non-priority Data]

On the other hand, a B picture B300 (B picture packets B300-1 to B300-N) is transmitted at a transmission rate of 54 Mbps. These transmission rates are determined by the transmission control section 109 based on whether the packet to be transmitted, which is stored in the transmit data buffer 104, is “priority data” or “non-priority data”.

<Effects>

As described above, priority data is transmitted at a relatively slow transmission rate, while non-priority data is transmitted at a relatively fast transmission rate. In general, the slower the transmission rate is, the more likely the receiver receives the data successfully. That is, the priority data is more likely to be received successfully, while the non-priority data is transmitted faster. Accordingly, as compared with the conventional system, the priority data can be transmitted more preferentially, resulting in an improvement in the communication efficiency. As a result, more natural moving pictures can be presented to viewers (users) within a limited band.

The transmitting and receiving system of this embodiment is particularly effective for broadcast and multicast in which ACK packets cannot be sent back.

It should be noted that the example in which the transmission rates are set is applicable to the transmitting and receiving systems of both the first and second embodiments.

It should be further noted that the setting of maximum allowable delay time employed in the third embodiment is also applicable to the transmitting and receiving system of this embodiment.

Furthermore, it is possible to set two or more transmission rate levels.

(Fifth Embodiment)

<Structure>

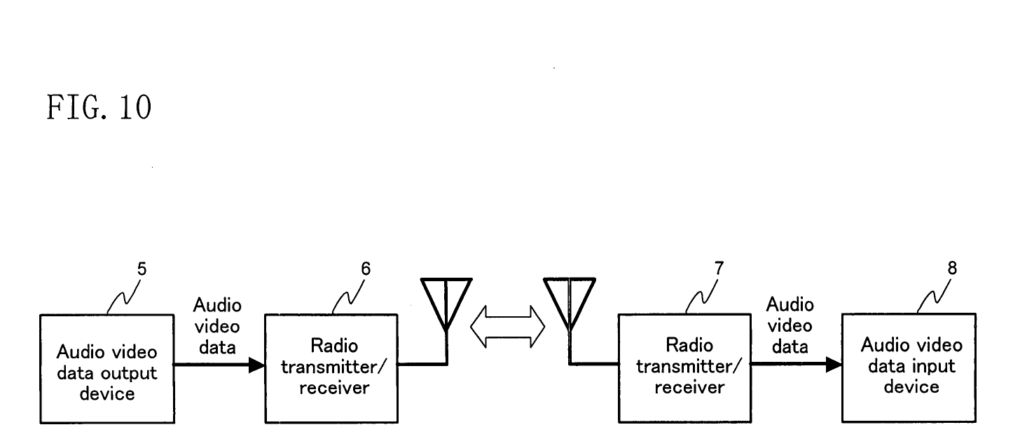

FIG. 10 illustrates the entire structure of a transmitting and receiving system according to a fifth embodiment of the present invention. The transmitting and receiving system includes an audio video data output device 5, radio transmitters/receivers 6 and 7, and an audio video data input device 8. The transmitting and receiving system of this embodiment transmits/receives audio video data in which video data and audio data have been multiplexed. The audio video data output device 5 outputs audio video data to the radio transmitter/receiver 6. The radio transmitter/receiver 6 transmits the audio video data received from the audio video data output device 5 to the radio transmitter/receiver 7 through a radio transmission path. The radio transmitter/receiver 7 outputs the audio video data received through the radio transmission path to the audio video data input device 8. The audio video data input device 8 receives the audio video data from the radio transmitter/receiver 7 and provides viewers (users) with the audio/video.

<Internal Structure of the Radio Transmitters/receivers>

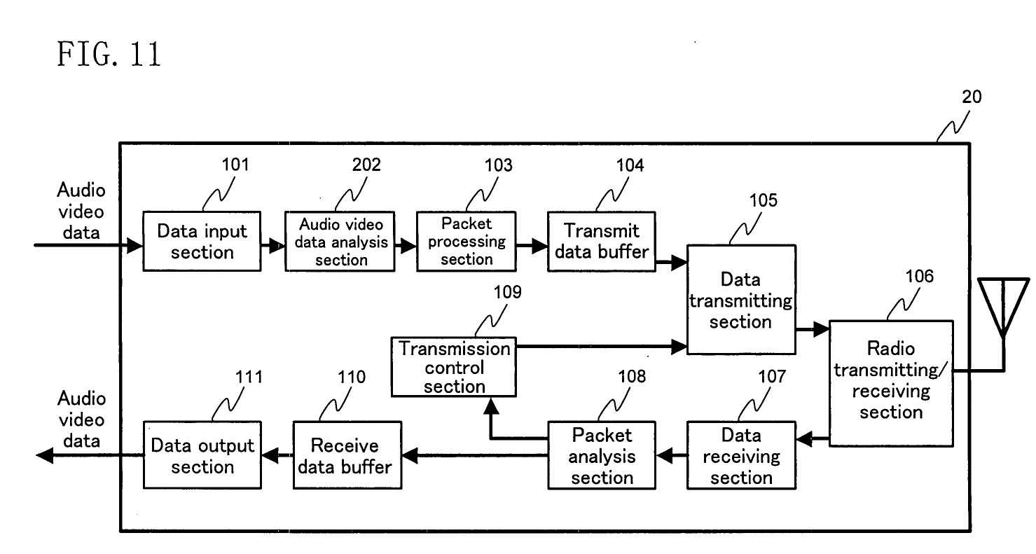

FIG. 11 illustrates the internal structure of the radio transmitters/receivers 6 and 7 shown in FIG. 10. Since the radio transmitters/receivers 6 and 7 have the same internal structure, they are represented by a radio transmitter/receiver 20 in FIG. 11.

The radio transmitter/receiver 20 includes an audio video data analysis section 202 in place of the picture analysis section 102 shown in FIG. 2. In the other respects, the structure of the radio transmitter/receiver 20 is the same as that shown in FIG. 2.

A data input section 101 receives multiplexed audio video data.

The audio video data analysis section 202 separates audio data and video data from the audio video data input by the data input section 101. The audio video data analysis section 202 also divides (packetizes) each of the separated audio data and video data in accordance with a packet size transmitted by radio. The audio video data analysis section 202 then determines whether or not data contained in each of the generated packets is video data or audio data.

A packet processing section 103 refers to the result of the determination made by the audio video data analysis section 202 and adds identification information to each packet generated by the audio video data analysis section 202. The identification information indicates whether the packet is “priority data” or “non-priority data”. In this process, the packet processing section 103 adds identification information indicating “priority data” to each packet containing audio data, while adding identification information indicating “non-priority data” to each packet containing video data.

<Configuration of MPEG-TS Packet>

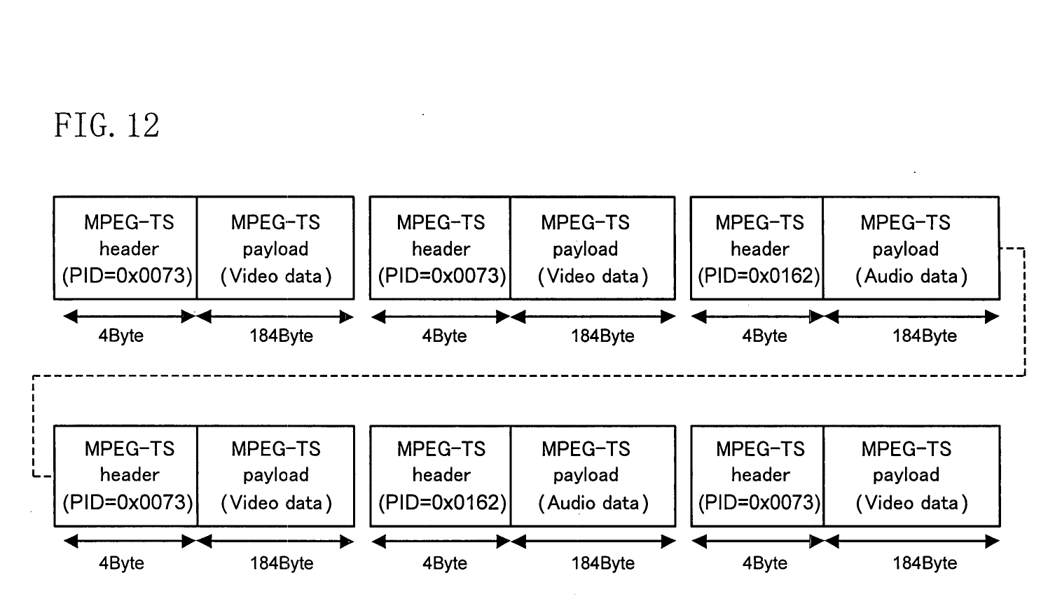

FIG. 12 illustrates the configurations of MPEG-TS packets. Each MPEG-TS packet contains a 4-byte MPEG-TS header and 184-byte MPEG-TS payload, and the MPEG-TS header contains a 13-bit PID indicating the type of data. In FIG. 12, an MPEG-TS header in which PID=0x0162 is added to each MPEG-TS payload that contains audio data, while an MPEG-TS header in which PID=0x0073 is added to each MPEG-TS payload that contains video data.

The audio video data analysis section 202 can determine whether video data or audio data is contained in a packet by referring to the PID contained in the MPEG-TS header.

<Communication Sequence>

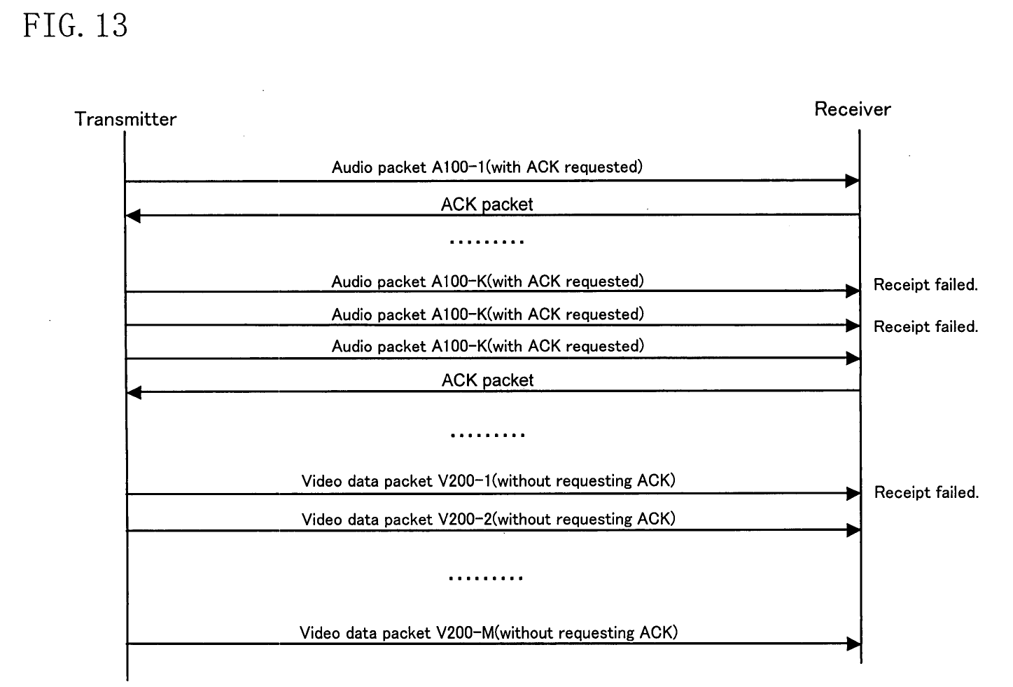

With reference to FIG. 13, operation of the transmitting and receiving system shown in FIG. 10 will be described.

[Priority Data]

As in the first embodiment, when audio packets A100-1 to A100-K (where K is a natural number), which are priority data, are transmitted, it is requested that ACK packets be sent back as acknowledgement of receipt of these packets (these packets are transmitted with ACK packets being requested).

Also, as in the case of the audio packet A1OO-K, if a packet has failed to be received by the receiver due to the packet loss, an error or the like, the packet analysis section 108 in the receiver does not instruct the transmission control section 109 to send back an ACK packet. In this case, in the transmitter, the transmission control section 109 does not receive a notification of receipt of an ACK packet and therefore retransmits the packet (the audio packet A1OO-K) that has failed to be received.

[Non-priority Data]

As in the first embodiment, when video data packets V200-1 to V200-M (where M is a natural number) that are non-priority data are transmitted, ACK packets are not requested to be sent back as acknowledgement of receipt of these packets (these packets are transmitted without requesting ACK packets).

In the receiver, even if an error is detected with respect to a received packet (for example, the video data packet V200-1), the packet analysis section 108 does not instruct the transmission control section 109 to send an ACK packet.

In this case, although no ACK packet is sent back, the transmission control section 109 in the transmitter recognizes that the data transmitted by the data transmitting section 105 is “non-priority data” and therefore does not retransmit that packet (the video data packet V200-1) that has failed to be received.

<Effects>

As described above, the audio packets are transmitted preferentially. In general, if there is audio data missing, an unusual sound occurs to make users uncomfortable significantly. The transmitting and receiving system of this embodiment is thus capable of presenting more natural audio video to users within a limited transmission band.

Although the case in which MPEG-TS data is used as audio video data has been described in this embodiment, the present invention is not limited to this case but is applicable to any audio video data, so long as the audio video data has a data format in which video data and audio data is multiplexed together.

Also, this embodiment has been described based on the transmitting and receiving system (in which priority control is performed according to whether or not an ACK packet request is necessary) of the first embodiment. Nevertheless, this embodiment is applicable to the transmitting and receiving system (in which priority control is performed by limiting the allowable number of retransmissions) of the second embodiment, to the transmitting and receiving system (in which priority control is performed by limiting the maximum allowable delay time) of the third embodiment, and to the transmitting and receiving system (in which priority control is performed by setting transmission rates) of the fourth embodiment.

In the foregoing embodiments, radio is used as a transmission path, but even if the transmission path is a cable, similar effects are achievable.

Furthermore, although MPEG2 data is used as video data in the foregoing description, the present invention is not limited to this, but is applicable to any video data having configuration using I, P, and B pictures.

What is claimed is:

1. A transmitting and receiving system for exchanging, between a transmitter and a receiver, communication data indicating either a first data attribute or a second data attribute having a lower priority in communications than the first data attribute,
wherein the transmitter includes:
a data input section for receiving the communication data,
a first analysis section for determining a data attribute of the communication data received by the data input section, and
a first transmitting section in which an allowable number of retransmissions for communication data indicating the second data attribute is limited, wherein if the first analysis section determines that the communication. data indicates the first data attribute, the first transmitting section transmits that communication data and requests that an acknowledgement signal be sent back, and if the first analysis section determines that the communication data indicates the second data attribute, the first transmitting section transmits that communication data and requests that the acknowledgement signal be sent back according to the allowable number of retransmissions; the receiver includes:
a receiving section for receiving the communication data from the transmitter,
a second analysis section for, when the receiving section receives the communication data, determining whether or not an acknowledgement signal for that communication data needs to be sent back, and
a second transmitting section for, if the second analysis section determines that the acknowledgement signal needs to be sent back, sending back the acknowledgement signal; where the first transmitting section transmits the communication data indicating the first data attribute, if the acknowledgement signal is not sent back, the first transmitting section retransmits that communication data, and where the first transmitting section transmits the communication data indicating the second data attribute, the first transmitting section retransmits that communication data in accordance with the allowable number of retransmissions and presence or absence of the acknowledgement signal sent back; and
the allowable number of retransmissions for the communication data indicating the second data attribute is smaller than that for the communication data indicating the first data attribute.

2. The transmitting and receiving system of claim 1, wherein when the first analysis section determines that the communication data indicates the first data attribute, the first transmitting section transmits that communication data and requests that the acknowledgement signal be sent back, and when the first analysis section determines that the communication data indicates the second data attribute, the first transmitting section transmits that communication data without requesting that the acknowledgement signal be sent back; and
where the first transmitting section transmits the communication data indicating the first data attribute, if the acknowledgement signal is not sent back, the first transmitting section retransmits that communication data, and where the first transmitting section transmits the communication data indicating the second data attribute, the first transmitting section does not retransmit that communication data.

3. The transmitting and receiving system of claim 1, wherein the first transmitting section transmits the communication data received by the data input section and requests that the acknowledgement signal be sent back; and
if the acknowledgement signal for the communication data is not sent back, the first transmitting section retransmits that communication data, but in a case in which that communication data indicates the first data attribute, if the number of times that communication data has been retransmitted exceeds M (where M is an integer equal to or greater than 2), the first transmitting section discontinues the retransmission of that communication data, and in a case in which that communication data indicates the second data attribute, if the number of times that communication data has been retransmitted exceeds N (where N is an integer equal to or greater than 1 but smaller than M), the first transmitting section discontinues the retransmission of that communication data.

4. The transmitting and receiving system of claim 3, wherein after the discontinuation of the retransmission of the communication data indicating the second data attribute, if communication data that is next to be transmitted indicates the second data attribute and that communication data relates to the communication data the retransmission of which was discontinued, the first transmitting section does not transmit that communication data indicating the second data attribute, and if the communication data that is next to be transmitted indicates the first data attribute, the first transmitting section transmits that communication data indicating the first data attribute.

5. The transmitting and receiving system of claim 1, wherein the transmitter further includes a measurement section for measuring a time period between the receipt of the communication data by the data input section and completion of transmission of that communication data by the first transmitting section; and
in a case in which the time period measured by the measuring section exceeds a predetermined time period, if communication data that is next to be transmitted indicates the second data attribute, the first transmitting section does not transmit that communication data indicating the second data attribute, and if the communication data that is next to be transmitted indicates the first data attribute, the first transmitting section transmits that communication data indicating the first data attribute.

6. The transmitting and receiving system of claim 1, wherein when the first transmitting section transmits the communication data indicating the first data attribute, the first transmitting section transmits that communication data at a first transmission rate, and when the first transmitting section transmits the communication data indicating the second data attribute, the first transmitting section transmits that communication data at a second transmission rate, which is faster than the first transmission rate.

7. A transmitter for transmitting communication data indicating either a first data attribute or a second data attribute having a lower priority in communications than the first data attribute and for receiving an acknowledgement signal from a receiver, the transmitter comprising:
a data input section for receiving the communication data,
an analysis section for determining a data attribute of the communication data received by the data input section, and
a transmitting section in which an allowable number of retransmissions for communication data indicating the second data attribute is limited, wherein if the analysis section determines that the communication data indicates the first data attribute, the transmitting section transmits that communication data and requests that an acknowledgement signal be sent back, and if the analysis section determines that the communication data indicates the second data attribute, the transmitting section transmits that communication data and requests that the acknowledgement signal be sent back according to the allowable number of retransmissions,
wherein where the transmitting section transmits the communication data indicating the first data attribute, if the acknowledgement signal is not sent back, the transmitting section retransmits that communication data, and where the transmitting section transmits the communication data indicating the second data attribute, the transmitting section retransmits that communication data in accordance with the allowable number of retransmissions and presence or absence of the acknowledgement signal sent back; and
the allowable number of retransmissions for the communication data indicating the second data attribute is smaller than that for the communication data indicating the first data attribute.

8. The transmitter of claim 7, wherein when the analysis section determines that the communication data indicates the first data attribute, the transmitting section transmits that communication data and requests that the acknowledgement signal be sent back, and when the analysis section determines that the communication data indicates the second data attribute, the transmitting section transmits that communication data without requesting that the acknowledgement signal be sent back; and
where the transmitting section transmits the communication data indicating the first data attribute, if the acknowledgement signal is not sent back, the transmitting section retransmits that communication data, and where the transmitting section transmits the communication data indicating the second data attribute, the transmitting section does not retransmit that communication data.

9. The transmitter of claim 7, wherein the transmitting section transmits the communication data received by the data input section and requests that the acknowledgement signal be sent back; and
if the acknowledgement signal for the communication data is not sent back, the transmitting section retransmits that communication data, but in a case in which that communication data indicates the first data attribute, if the number of times that communication data has been retransmitted exceeds M (where M is an integer equal to or greater than 2), the transmitting section discontinues the retransmission of that communication data, and in a case in which that communication data indicates the second data attribute, if the number of times that communication data has been retransmitted exceeds N (where N is an integer equal to or greater than 1 but smaller than M), the transmitting section discontinues the retransmission of that communication data.

10. The transmitter of claim 9, wherein after the discontinuation of the retransmission of the communication data indicating the second data attribute, if communication data that is next to be transmitted indicates the second data attribute and that communication data relates to the communication data the retransmission of which was discontinued, the transmitting section does not transmit that communication data indicating the second data attribute, and if the communication data that is next to be transmitted indicates the first data attribute, the transmitting section transmits that communication data indicating the first data attribute.

11. The transmitter of claim 7, further comprising a measurement section for measuring a time period between the receipt of the communication data by the data input section and completion of transmission of that communication data by the transmitting section,
wherein in a case in which the time period measured by the measuring section exceeds a predetermined time period, if communication data that is next to be transmitted indicates the second data attribute, the transmitting section does not transmit that communication data indicating the second data attribute, and if the communication data that is next to be transmitted indicates the first data attribute, the transmitting section transmits that communication data indicating the first data attribute.

12. The transmitter of claim 7, wherein when the transmitting section transmits the communication data indicating the first data attribute, the transmitting section transmits that communication data at a first transmission rate, and when the transmitting section transmits the communication data indicating the second data attribute, the transmitting section transmits that communication data at a second transmission rate, which is faster than the first transmission rate.

13. The transmitter of claim 7, wherein the communication data indicating the first data attribute contains picture data that is referred to when other picture data is decoded; and
the communication data indicating the second data attribute contains picture data that is not referred to when other picture data is decoded.

14. The transmitter of claim 7, wherein the communication data indicating the first data attribute contains audio data; and
the communication data indicating the second data attribute contains video data.

15. A transmitting method in which a transmitter receives communication data indicating either a first data attribute or a second data attribute having a lower priority in communications than the first data attribute and receives an acknowledgement signal from a receiver, the method comprising the steps of:
(a) determining a data attribute of the communication data received by the transmitter;
(b) if it is determined in the step (a) that the communication data indicates the first data attribute, transmitting that communication data and requesting that an acknowledgement signal be sent back, and if it is determined in the step (a) that the communication data indicates the second data attribute, transmitting that communication data and requesting that the acknowledgement signal be sent back according to an allowable number of retransmissions for the communication data indicating the second data attribute; and
(c) where the communication data indicating the first data attribute is transmitted in the step (b), if the acknowledgement signal is not sent back, retransmitting that communication data, and where the communication data indicating the second data attribute is transmitted in the step (b), retransmitting that communication data in accordance with the allowable number of retransmissions and presence or absence of the acknowledgement signal sent back,
wherein the allowable number of retransmissions for the communication data indicating the second data attribute is smaller than that for the communication data indicating the first data attribute.

16. The transmitting method of claim 15, wherein if it is determined in the step (a) that the communication data indicates the first data attribute, in the step (b) that communication data is transmitted and the acknowledgement signal is requested to be sent back, and if it is determined in the step (a) that the communication data indicates the second data attribute, in the step (b) that communication data is transmitted without requesting that the acknowledgement signal be sent back; and
if, in the step (b), the communication data indicating the first data attribute is transmitted but the acknowledgement signal is not sent back, that communication data is retransmitted in the step (c), and if, in the step (b), the communication data indicating the second data attribute is transmitted, that communication data is not retransmitted in the step (c).

17. The transmitting method of claim 15, wherein, in the step (b), the communication data received by the transmitter is transmitted and the acknowledgement signal is requested to be sent back; and
in the step (c), if the acknowledgement signal for the communication data transmitted in the step (b) is not sent back, that communication data is retransmitted, but in a case in which that communication data indicates the first data attribute, if the number of times that communication data has been retransmitted exceeds M (where M is an integer equal to or greater than 2), the retransmission of that communication data is discontinued, and in a case in which that communication data indicates the second data attribute, if the number of times that communication data has been retransmitted exceeds N (where N is an integer equal to or greater than 1 but smaller than M), the retransmission of that communication data is discontinued.

18. The transmitting method claim 17, further comprising the step of:
(d) after the discontinuation of the retransmission of the communication data indicating the second data attribute in the step (c), if communication data that is next to be transmitted indicates the second data attribute and that communication data relates to the communication data the retransmission of which was discontinued, canceling transmission of that communication data indicating the second data attribute, and if the communication data that is next to be transmitted indicates the first data attribute, transmitting that communication data indicating the first data attribute.

19. The transmitting method of claim 15, further comprising the steps of:
(d) measuring a time period between the receipt of the communication data by the transmitter and completion of transmission of that communication data by the transmitter; and
(e) in a case in which the time period measured in the step (d) exceeds a predetermined time period, if communication data that is next to be transmitted indicates the second data attribute, canceling transmission of that communication data indicating the second data attribute, and if the communication data that is next to be transmitted indicates the first data attribute, transmitting that communication data indicating the first data attribute.

20. The transmitting method of claim 15, wherein in the step (b), when the communication data indicating the first data attribute is transmitted, that communication data is transmitted at a first transmission rate, and when the communication data indicating the second data attribute is transmitted, that communication data is transmitted at a second transmission rate, which is faster than the first transmission rate.
